(19) United States
(12) Patent Application Publication
(10) Pub. No.: US 2013/0110612 A1
(43) Pub. Date: May 2, 2013

(54) SYSTEM AND METHOD FOR ENABLING USE OF POINTS FROM A LOYALTY PROGRAM AS PAYMENT

(71) Applicant: Switchfly, Inc., San Francisco, CA (US)

(72) Inventor: Christopher Boyd, Oakland, CA (US)

(73) Assignee: SWITCHFLY, INC., San Francisco, CA (US)

(21) Appl. No.: 13/665,539

(22) Filed: Oct. 31, 2012

Related U.S. Application Data
(60) Provisional application No. 61/553,482, filed on Oct. 31, 2011.
(60) Provisional application No. 61/645,520, filed on May 10, 2012.

(51) Int. Cl. G06Q 30/02

(52) U.S. Cl. 705/14.33

(57) ABSTRACT

A method and system for offering a loyalty program deal to a target customer and for enabling use of points from a loyalty program as payment. In one preferred embodiment, the method may include the steps receiving from the loyalty program, information related to a loyalty program deal; storing the received loyalty program deal information on a server; notifying at least one target customer from the target customer segment of the loyalty program deal; receiving from a merchant, a points price request for a product selected for a purchase transaction; determining an initial points price for the selected product based on a cash-to-points pricing factor; determining an updated points price for the selected product based on the loyalty program deal; debiting a number of points from a loyalty program account of the target customer; and notifying the loyalty program that the loyalty program deal has been claimed by the customer.

### CLAIM OF PRIORITY

The present application claims priority to: U.S. Provisional Patent Application Ser. No. 61/553,482 entitled “Method for enabling use of loyalty program points as payment” and filed on 31 Oct. 2011; and claims priority to U.S. Provisional Patent Application Ser. No. 61/645,520 entitled “Method for enabling use of points from a loyalty program as payment” and filed on 10 May 2012, which are both incorporated in their entirety by this reference.

### TECHNICAL FIELD

This invention relates generally to the loyalty program rewards field, and more specifically to a new and useful system and method for offering a loyalty program deal to a target customer and for enabling use of points from a loyalty program as payment.

### BACKGROUND

Internet technology has revolutionized travel management, providing user-friendly online booking. Many loyalty programs encourage loyalty by awarding loyalty program points to users for purchases with the same supplier, i.e. the supplier of the loyalty program. The users may then redeem these loyalty program points for further travel or other related goods or services. However, present day redemption systems are inefficient and limited in options. Users may only redeem their loyalty program points for goods and services that are directly related to travel—other flights, hotels, tours, rental cars, and the like. Furthermore, loyalty program members are currently limited to a slim catalog when redeeming points for merchandise. They expect, however, the product breadth offered by the biggest retailers, as well as merchandise that is available in high-demand seasons such as the holidays. Furthermore, loyalty programs do not have the ability to engage with their customers in an effective manner, nor do they have the ability to influence customer behavior in a meaningful way. Thus, there is a need in the field of loyalty programs such as travel rewards programs to create a new and useful method and system for enabling use of loyalty program points as form of payment and for offering a loyalty program deal to a target customer. This invention provides such a new and useful method and system.

### BRIEF DESCRIPTION OF THE FIGURES

FIG. 1 is a schematic of the system of a preferred embodiment;

FIGS. 2A, 2B, and 2C are example schematics of the user interface, the loyalty program deals database, and the pricing factors database, respectively, in the system of a preferred embodiment; and

FIGS. 3-5 are flowcharts depicting the method of a preferred embodiment and variations thereof.

### DESCRIPTION OF THE PREFERRED EMBODIMENTS

The following description of preferred embodiments of the invention is not intended to limit the invention to these preferred embodiments, but rather to enable any person skilled in the art to make and use this invention.

System for Enabling Use of Points from a Loyalty Program as Payment

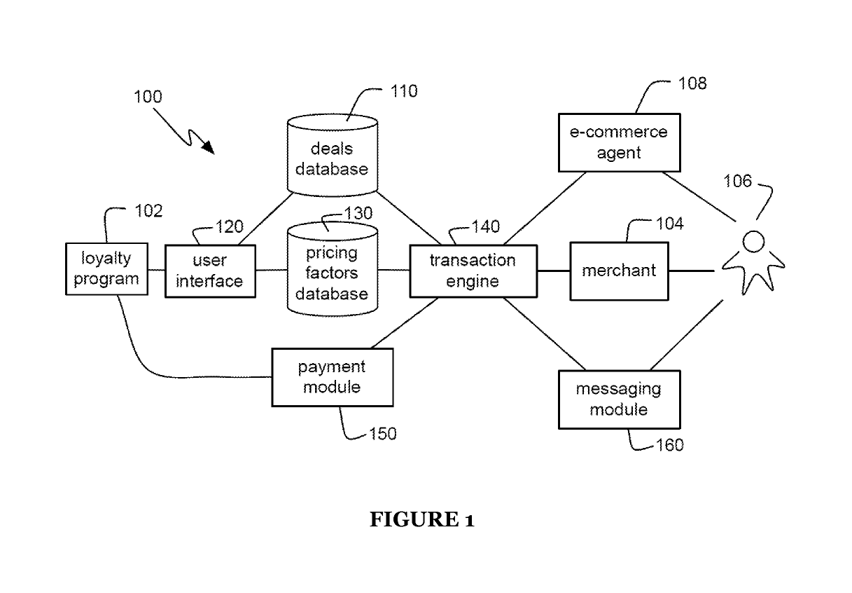

As shown in FIG. 1, in a preferred embodiment, a system 100 for offering a loyalty program deal to a target customer and for enabling use of points from a loyalty program 102 as payment includes: a loyalty program deals database 110 configured to store information related to a loyalty program deal specific to at least one of a target customer 106 and a merchant 104; a pricing factors database 130 configured to store a plurality of cash-to-points pricing factors associated with at least one of loyalty programs, target customer segments, merchants, and selected products; a transaction engine 140 coupled to the loyalty program deals database 110 and configured to determine an initial points price for a product selected by the target customer 106 based on a selected cash-to-points pricing factor, and to determine an updated points price for the selected product based on the loyalty program deal and at least one of the target customer, target customer segment, the merchant, and the selected product; a payment module 150 configured to debit a loyalty program account of the target customer; and a messaging module 160 coupled to the transaction engine and configured to communicate information to at least one of the loyalty program and the target customer. The initial points price for the selected product is preferably based on a cash-to-points pricing or conversion factor associated with at least one of the target customer and the selected product. The system 100 preferably includes a pricing rules database configured to store a plurality of cash-to-points pricing factors. In some preferred embodiments, the system 100 includes a user interface configured to receive information related to, and to enable management of, loyalty program deals to be stored in the loyalty program deals database no.

The system 100 preferably enables loyalty programs, such as those for frequent flyer programs offered by airlines, or similar loyalty programs offered by hotels or other travel service providers, to allow loyalty program members or consumers to use loyalty program points (e.g., miles) as payment at a point-of-sale (POS). In particular, the system 100 preferably enables loyalty programs and/or merchant partners at the POS to offer particular discounts to the loyalty program members at particular merchants and at particular times. The system preferably enables the loyalty programs to engage with customers in a constant, meaningful, and real-time fashion with customers wherever they are. Additionally the system preferably facilitates a revenue stream for the loyalty program from the merchant purchasing of points while benefiting the merchant by driving customer volume. The loyalty program deal can be a discount (e.g., $10 off a suitable product type or order total), a bonus offer (e.g., free 1000 points, miles, or amount of monetary currency towards a suitable product type or order total), or any suitable kind of deal or promotion at a particular merchant or set of multiple merchants. As used herein, the term “product” is used to refer to a transaction including any combination of one or more types of goods and/or services. The product can be one or more tangible items (physical object) or intangible items, or a combination thereof. Alternatively, the system 100 enables loyalty programs and/or merchant partners to offer discounts on one or more other suitable types of goods and services.

As shown in FIG. 1, the system of the preferred embodiment includes a loyalty program deals database no configured to store information related to a loyalty program deal specific to at least one of a target customer segment and a merchant. The loyalty program deals database no preferably functions to store information related to one or more loyalty programs deals. The loyalty program deals may be specific to at least one of a target customer segment and a merchant. For example, the loyalty program may wish for a specific group or segment of customers to utilize their loyalty program points for a purchase (for example, customers having more than a certain number of points, premier customers, and/or new customers), and may therefore target the loyalty program deal at those target customers. Alternatively, the loyalty program may wish to drive customers to a specific merchant (for example, a specific merchant may purchase loyalty points from the loyalty program at a preferred rate), and may therefore offer a deal only with that specific merchant.

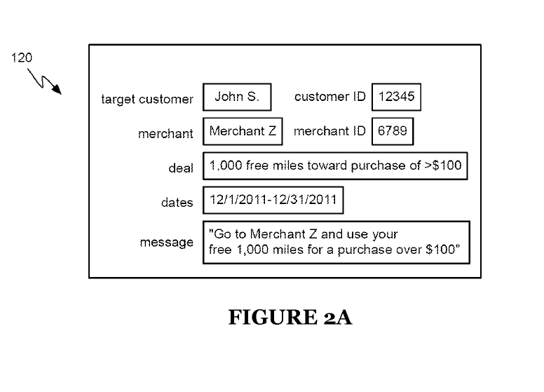

As shown in FIG. 2B, the loyalty program deals database no preferably stores at least one of the following: identification of a target customer (e.g., member identification number, name, and/or customer segment or tier), identification of a merchant partner where the deal is applicable (e.g., merchant identification number or name), description of deal (e.g., text summary of deal or deal identification number), deal lifetime (e.g., dates and/or times between which the deal is valid or redeemable), and text of deal notification message or messages to be sent to the target customer. Other information related to the loyalty program deals may include target customer demographics (such as suitable identifiers or descriptors corresponding to age, gender, race, geographical location, customer interests or other suitable customer profile details), deal exceptions or inclusions (e.g., restrictions on product types applicable towards the deal, limits on number of times the deal may be redeemed total and/or per customer), or any suitable information relating to a loyalty program deal. The loyalty program deals database 110 is preferably stored on a server, cloud storage, or other storage device or network that is accessible by one or more computing devices.

In a preferred embodiment, as shown in FIG. 1, the system 100 further includes a user interface 120 configured to receive the loyalty program deal information (e.g., from one or more loyalty programs 102) and transmit the loyalty program deal information to the loyalty program deals database no. For example, in one preferred variation, as shown in FIG. 2A, the user interface 120 includes fields, each for a respective expected detail of the deal such as customer identification and merchant identification and/or a field for general information about the deal. However, in alternative variations the user interface 120 can be in any suitable configuration to receive the loyalty program deal information. The user interface 120 can further be configured to enable management of the various loyalty program deals, including modifications and/or deletions of deals.

As shown in FIG. 1, in a preferred embodiment, the system 100 includes a pricing factors database 130 configured to store a plurality of cash-to-points pricing factors associated with at least one of loyalty programs, target customer segments, merchants, and selected products. The cash-to-points pricing factors that convert between a cash price of a product (i.e., monetary currency) and a points price of a product (i.e. loyalty program points, or “miles”). The points price of a product is equal to a number of loyalty program points that are equivalent to the cash price based on the specific cash-to-points pricing factor. The pricing factors database 130 is preferably configured to store various tiers of cash-to-points (cash-to-points and/or points-to-cash) pricing factors. As shown in FIG. 2C, each factor preferably corresponds to a particular attribute of a product (e.g. cost, product type, brand, availability), a particular customer (e.g. demographic, individual), and/or a particular merchant 104 (e.g., type, location, individual), and/or any suitable categorization. Like the loyalty program deals database no, the pricing factors database 130 is preferably stored on a server or other storage device that is accessible by one or more computing devices. In some embodiments, the pricing factors database can be coupled to the loyalty program deals database 110, such as to enable a loyalty program deal to specify and/or adjust a particular cash-to-points pricing factor value. In some alternative embodiments, the pricing factors database and/or the loyalty program deals database may be stored on a server, computer, or other storage device associated with or otherwise connected to the loyalty program such that representatives from the loyalty program may populate and control the data stored within the database directly. In this embodiment, the system may send a request to the loyalty program for the appropriate pricing factor and/or deal given the target customer segment, the merchant, the selected product(s), or any other suitable criteria.

As shown in FIG. 1, the transaction engine 140 is coupled to the loyalty program deals database 110 and the pricing factors database 130 and is configured to determine an initial points price for a product selected by the target customer based on a selected cash-to-points pricing factor, and to determine an updated points price for the selected product based on the loyalty program deal and at least one of the target customer, the target customer segment, the merchant, and the selected product. The transaction engine 140 preferably functions to facilitate a transaction involving a product selected at the merchant 104 by the target customer and to apply any valid loyalty program deals toward the transaction. The transaction engine 140 is preferably configured to determine an initial points price for the selected product based on a cash-to-points pricing factor, and to determine an updated points price for the selected product based on the loyalty program deal. The transaction engine 140 preferably communicates with a payment wallet or other e-commerce agent 108 (e.g., PayPal Wallet), which interfaces with the merchant 104 during the transaction of the target customer. In particular, as further described in the method described below, the transaction engine 140 preferably receives a request from the e-commerce agent 108 for the price in points of the selected product for the target customer at the merchant 104, and/or provides the price in points to the e-commerce agent 108. However, alternatively the transaction engine 140 can communicate and interface directly with the merchant 104. In a preferred embodiment, the transaction engine 140 is implemented on a controller or a processor of a computing device, and can be configured to perform at least some of the processes described in the method below.

In determining an initial points price for the selected product, the transaction engine 140 preferably communicates with the pricing factors database 130 to determine an appropriate cash-to-points pricing factor for the selected product. In one embodiment, the transaction engine 140 determines the pricing factor by table lookup. In alternative embodiments, the transaction engine 140 determines the pricing factor by algorithm or in any suitable process. If the transaction involves multiple goods or services, the transaction engine 140 preferably communicates with the pricing factors database to determine an appropriate respective cash-to-points pricing factor for each good or service. Alternatively, a single pricing factor can apply to a group or particular set of multiple goods and services.

As described above, the cash-to-points pricing factors are associated with at least one of loyalty programs, target customer segments, merchants, and selected products. The transaction engine 140 may select the cash-to-points pricing factor from the pricing factors database based on stored instructions, or may alternatively request and receive instructions (or the actual cash-to-points pricing factor) from the appropriate loyalty program. The cash-to-points pricing factor may be selected based on at least one of several factors including the loyalty program, the target customer segment, the merchant, and the selected product. For example, different loyalty programs may offer different pricing factors to the same customer. For example, the customer may have more loyalty program points with a first program, and may therefore receive a more favorable conversion factor from that program. In some embodiments, the conversion factor may be selected based on the customer segment. For example, a premier or higher tier customer may receive a more favorable conversion factor and a lower level customer. In some embodiments, the conversion factor may be selected based on the merchant. For example, loyalty programs may wish to encourage the use of points as a form a payment with a select few preferred merchants, and may therefore offer a more favorable conversion factor for those merchants. In some embodiments, loyalty programs may wish to encourage the use of points as a form a payment for a select few preferred products or services, and may therefore offer a more favorable conversion factor for those purchases. In some embodiments, the conversion factor may be selected based on any other suitable criteria or a combination of any suitable criteria.

In determining an updated points price for the selected product, the transaction engine 140 preferably communicates with the loyalty program deals database no. The transaction engine 140 preferably searches and/or identifies any applicable deals (e.g., discounts or bonuses) by product item, order total, customer, merchant, transaction date/time, and/or any suitable parameter. The transaction engine 140 preferably verifies that the transaction satisfies any other restrictions specified in the loyalty program deal, such as deal lifetime or number of times the deal is redeemable in total or redeemable per customer.

The transaction engine 140 preferably determines an updated points price based on the applicable deal. For example, the updated points price may be lower than the initial points price by a points discount amount specified in the applicable loyalty program deal. For example, consider the initial points price of 50,000 points for a tablet computer with a cash price of $500, based on a cash-to-points conversion factor of 100 points/dollar. The loyalty program deal offers “free 1,000 points for a purchase over $100”. Therefore the updated points price would be 49,000 points. Alternatively, consider an example where the deal offers “your points go farther with any purchase over $250”. For the same initial points price of 50,000 points for a tablet computer with a cash price of $500, based on a cash-to-points conversion factor of 100 points/dollar, the updated points price may be based on an alternative conversion factor. For example, the loyalty program may instruct that based on the “your points go further” deal described, the conversion factor becomes 90 points/dollar. Therefore, the updated points price, based on the loyalty program deal becomes 45,000 points for a tablet computer with a cash price of $500.

In some embodiments, multiple loyalty program deals stored in loyalty program deals database 110 may be valid for a particular transaction. In one variation, the transaction engine 140 may automatically select one of the valid loyalty program deals (or any other number of the valid deals) based one or more suitable parameters of the deal, such as expiration date of the deal, or amount of the discount or bonus of the deal (e.g., select the deal most advantageous to the customer or most advantageous to the loyalty program). In a second variation, the transaction engine 140 may automatically determine and apply all valid loyalty program deals toward the transaction. In a third variation, the transaction engine 140 may present to the customer some or all of the valid loyalty program deals and receive a selection from the customer of a particular loyalty program deal to apply toward the transaction.

As shown in FIG. 1, the payment module 150 is configured to debit a loyalty program account of the target customer. More specifically, the payment module is configured to debit a number of loyalty program points from the customer's account. The number of loyalty program points debited is preferably equal to the updated points price. In some examples however, the loyalty program deal may not apply to the customer and/or the target customer may decide to not utilize the deal, and therefore the number of loyalty program points debited may be equal to the initial points price. Alternatively, in some examples, the user may wish to pay both with points and cash, and therefore the number of loyalty program points debited may be less than the updated points price. In some embodiments, the payment module may be configured to debit a cash amount from a customer's cash currency account, debit card, credit card, gift card, etc. In some embodiments, the cash payment methods may be linked, or otherwise associated with an e-commerce agent or payment partner wallet.

The payment module 150 preferably functions to at least partially facilitate payment from the customer for the transaction. The payment module 150, which is preferably implemented on a processor of a computing device, preferably receives an indication of an amount of points (e.g., points or number of frequent flyer miles) to debit from a loyalty program account of the customer and/or one or more cash currency accounts. For example, in response to an indication that the customer wishes to pay entirely in loyalty program points, the payment module 150 preferably debits, as payment for the transaction, the updated points price for the selected product from solely the loyalty program account of the customer. In alternative embodiments, payment may include only cash currency or a combination of points and cash currency, similar to the system described in U.S. patent application Ser. No. 11/430,329 entitled, “Dynamic real-time point redemption in travel booking”, filed 8 May 2006, the entirety of which is incorporated herein by this reference. The indication of an amount to debit can be received from the transaction engine, the e-commerce agent, directly from the customer, and/or any suitable source. In some variations, the payment module 150 can be implemented in the e-commerce agent, in the transaction engine, or separately and independently.

As shown in FIG. 1, the system 100 further includes a messaging module 160 coupled to the transaction engine and configured to communicate information to at least one of the loyalty program and the target customer. In one variation, the messaging module 160 is preferably configured to send a message to the customer notifying the customer of an available loyalty program deal (e.g., with text of the deal notification message specified in the loyalty program deals database 110). In another variation, the messaging module 160 additionally or alternatively is configured to send a message to the customer notifying the customer that a particular loyalty program deal has been applied to the transaction (e.g., including the updated points price). The messaging module may also be configured to communication with the loyalty programs and/or merchants. For example, the messaging module may be configured to notify the loyalty program and/or merchant that the loyalty program deal has been claimed by the target customer. The messaging module 160 can be configured to provide a message to the customer, loyalty program, or other suitable recipient through email, SMS, within a website associated with the loyalty program, within a computer or mobile device application, postal mail, and/or any suitable medium. The messaging module 160 is preferably incorporated in or coupled to the transaction engine, but can additionally or alternatively be incorporated in the loyalty program, and/or separately in any suitable manner.

Method for Enabling Use of Points from a Loyalty Program as Payment

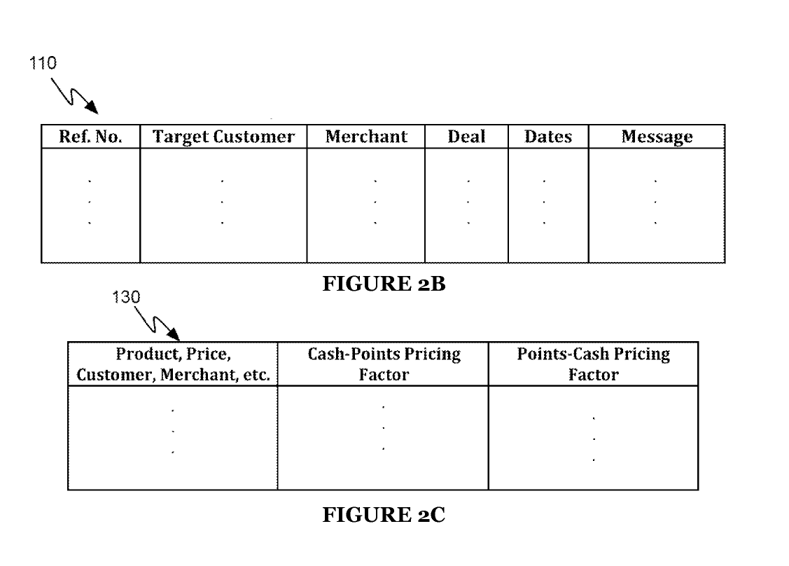

In a preferred embodiment, as shown in FIG. 3, a method 200 for offering a loyalty program deal to a target customer and for enabling use of points from a loyalty program as payment includes: receiving, from a first computer associated with the loyalty program, information related to a loyalty program deal specific to at least one of a target customer segment and a merchant in block S210, storing the received loyalty program deal information and at least one of target customer information and merchant information on a server in block S220, notifying at least one target customer from the target customer segment of the loyalty program deal in block S230; receiving, from a second computer associated with a merchant, a points price request for a product selected for a purchase transaction by the target customer in block S240; determining an initial points price for the selected product based on a cash-to-points pricing factor associated with at least one of the loyalty program, the target customer, the target customer segment, the merchant, and the selected product in block S250; determining an updated points price for the selected product based on the loyalty program deal and at least one of the target customer, the target customer segment, the merchant, and the selected product in block S270; debiting a number of points equal to at least a portion of the updated points price from a loyalty program account of the target customer in block S280; and notifying the loyalty program that the loyalty program deal has been claimed by the target customer in block S290. The method preferably enables loyalty programs, such as those for frequent flyer programs offered by airlines, or similar loyalty programs offered by hotels or other travel service providers, to allow loyalty program members or consumers to use loyalty program points (e.g., miles) as payment at a point-of-sale (POS). In particular, the method preferably enables loyalty programs and/or merchant partners at the POS to offer particular discounts to the loyalty program members at particular merchants and at particular times. The method preferably enables the loyalty programs to engage with customers in a constant, meaningful, and real-time fashion with customers wherever they are. Additionally the method preferably facilitates a revenue stream for the loyalty program from the merchant purchasing of points while benefiting the merchant by driving customer volume.

As shown in FIG. 3, the preferred method includes Block S210 which recites receiving, from a first computer associated with the loyalty program, information related to a loyalty program deal specific to at least one of a target customer segment and a merchant. Block S210 preferably functions to obtain details of a loyalty program deal that may be applicable to a transaction. The received information may include identification of a target customer, identification of a merchant partner where the deal is applicable, description of the deal or deals, deal lifetime, and text of deal notification message or messages to be sent to the target customer. Other information related to the loyalty program deals may include target customer demographics, deal exceptions or inclusions, or any suitable information relating to a loyalty program deal. The information related to a loyalty program deal is preferably determined by the loyalty program offering the deal and received through a user interface. However, the information related to the loyalty program deal may additionally or alternatively be received through a face-to-face interaction, or in any suitable manner.

As shown in FIG. 3, the preferred method includes Block S220 which recites storing the received loyalty program deal information and at least one of target customer information and merchant information on a server. Block S220 preferably functions to retain the received information related to loyalty program deals in an accessible manner. The loyalty program deal information is preferably stored in a loyalty program deals database on a server or other storage device or cloud storage network accessible by a computing device. In some embodiments, the method includes organizing the loyalty program deal information for multiple loyalty program deals. In one variation, organizing the loyalty program deal information includes organizing the information in a table lookup according to one or more of the deal parameters (e.g., target customer information or merchant information). In another variation, organizing the loyalty program deal information includes tagging keywords of the received information. However, the loyalty program deal information can be organized in any suitable manner.

As shown in FIG. 3, the preferred method includes Block S230 which recites notifying at least one target customer from the target customer segment of the loyalty program deal. For example, the customer may be notified by being sent the stored deal notification message text. Block S230 preferably functions to inform and/or attract the target customer to spend his or her loyalty program points in a transaction. The target customer can be an individual customer or a particular customer demographic. Notifying the target customer of the loyalty program deal can be by email, SMS, within a computer or mobile device application, postal mail, and/or any suitable medium. Notifying the customer may be performed once for each new received and stored loyalty program deal, or be performed periodically or upon receiving and storing a predetermined threshold number of loyalty program deals to notify the customer of a batch of loyalty program deals. Furthermore, notifying the customer may be performed repeatedly, such as to remind the customer of available loyalty program deals. In some embodiments, the customer may be notified based on information specific to them or to their customer segment. For example, the customer may be notified of a deal on their birthday, anniversary with the loyalty program, upon being promoted to a higher customer segment or tier (e.g. from “silver”, to “gold”, to “platinum”), or for any other suitable event or reason. This customer information may be stored by the system described herein or alternatively or additionally by the loyalty program or merchant. The information may be updated at regular intervals, and/or upon the customer accessing the system, their merchant account, and/or their loyalty program account (by making a purchase with a merchant using loyalty program points, for example). The message may be delivered over email, SMS, within a website associated with the loyalty program, within a computer or mobile device application, postal mail, and/or any suitable medium. The customer contact information (e.g., email address or phone number) can be provided by the loyalty program, by a separate customer information database, and/or in any suitable manner.

As shown in FIG. 3, the preferred method includes Block S240 which recites receiving, from a second computer associated with a merchant, a points price request for a product selected for a purchase transaction by the target customer. In some embodiments, Block S240 may be performed through an e-commerce agent. For example, the merchant may be partnered with a specific e-commerce agent or other suitable payment system. Upon checkout, the user may be passed on to the e-commerce agent to facilitate online payment for the product or service. The e-commerce agent or payment partner may then request a points price for the selected product. Block S240 preferably functions to initiate conversion of a cash currency price of the product into points of a loyalty program. The points price request preferably includes identification of the product and/or cash currency price of the product, customer identification information, and/or merchant identification information. In one preferred embodiment, to initiate a transaction with loyalty program points, the customer logs into a payment wallet (e.g., PayPal) or other e-commerce agent before or after selecting a product for the transaction at a merchant. The points price request preferably is received from the merchant through a payment wallet (e.g., PayPal) or other e-commerce agent facilitating the transaction that the customer has logged into. However, in an alternative embodiment the points price request can be received directly from the customer, from the merchant involved in the transaction, or in any suitable manner.

As shown in FIG. 3, the preferred method includes Block S250 which recites determining an initial points price for the selected product based on a cash-to-points pricing factor associated with at least one of the loyalty program, the target customer, the target customer segment, the merchant, and the selected product. Block S250 preferably functions to convert the purchase price of a product from cash currency into a number of loyalty program points. The initial points price is preferably based on a cash-to-points pricing factor associated with at least one of the target customer and the selected product. For example, a cash-to-points pricing factor of 100 (100 points/dollar) or 0.01 ($ 0.01/point) applied to a product with a cash price of $50 results in an initial points price of $5,000 (50*100 or 50/0.01) for the product. In a preferred embodiment, the method includes searching a pricing factors database to determine an applicable cash-to-points pricing factor. For example, the applicable cash-to-points pricing factor can be found by searching a lookup table by product type, product dollar price, and/or any suitable parameter of the product. As another example, an applicable cash-to-points pricing factor can be found by searching a lookup table by identification information of a loyalty program deal (e.g., identification code), of the customer (e.g., name or loyalty program member account information), of the merchant, and/or any other suitable parameter of the transaction.

As described above, the cash-to-points pricing factors in the pricing factors database are associated with at least one of the loyalty programs, target customer segments, merchants, and selected products. The cash-to-points pricing factor may be found and/or selected from the pricing factors database based on stored instructions, or may alternatively requested and received instructions from the appropriate loyalty program. In some alternative embodiments, the pricing factor may be received from the loyalty program directly, thereby bypassing the database. The cash-to-points pricing factor may be selected based on at least one of several factors including the loyalty program, the target customer segment, the merchant, and the selected product. For example, different loyalty programs may offer different pricing factors to the same customer. For example, the customer may have more loyalty program points with a first program, and may therefore receive a more favorable conversion factor from that program. In some embodiments, the conversion factor may be selected based on the customer segment. For example, a premier or higher tier customer may receive a more favorable conversion factor and a lower level customer. In some embodiments, the conversion factor may be selected based on the merchant. For example, loyalty programs may wish to encourage the use of points as a form a payment with a select few preferred merchants, and may therefore offer a more favorable conversion factor for those merchants. In some embodiments, loyalty programs may wish to encourage the use of points as a form a payment for a select few preferred products or services, and may therefore offer a more favorable conversion factor for those purchases. In some embodiments, the conversion factor may be selected based on any other suitable criteria or a combination of any suitable criteria.

In a preferred embodiment, as shown in FIG. 3, the method includes block S260, which recites searching the loyalty program deals database for the applicable loyalty program deal. Block S260 preferably functions to match a loyalty program deal to the transaction and/or selected product. Searching the loyalty program deals database for an applicable loyalty program deal is preferably similar to searching a pricing factors database, preferably particularly in that an applicable loyalty program deal can be found by searching a lookup table by any suitable parameter of the product and/or transaction. In an alternative embodiment, the method includes receiving identification information of a loyalty program deal, such as a code corresponding to a loyalty program deal. In some preferred embodiments, the method includes verifying eligibility of the transaction for the loyalty program deal preferably includes checking the parameters of the transaction (e.g., customer, merchant, dates, product type, product cost) against the requirements or restrictions specified by the loyalty program deal.

In a preferred embodiment, as shown in FIG. 3, the method includes block S270, which recites determining an updated points price for the selected product based on the loyalty program deal and at least one of the target customer, the target customer segment, the merchant, and the selected product. Block S270 preferably functions to apply an applicable loyalty program deal to the transaction. The updated points price is preferably determined based on the specific details of the applicable loyalty program deal. For example, applying a loyalty program deal specifying “200 miles off any purchase at Store X” will result in an updated points price that is 200 miles less than the initial points price of the selected product. In other embodiments of the method, other suitable discounts and/or bonuses can be applied to the transaction. For example, as described above, consider the initial points price of 50,000 points for a tablet computer with a cash price of $500, based on a cash-to-points conversion factor of 100 points/dollar. The loyalty program deal offers “free 1,000 points for a purchase over $100”. Therefore the updated points price would be 49,000 points. Alternatively, consider an example where the deal offers “your points go farther with any purchase over $250”. For the same initial points price of 50,000 points for a tablet computer with a cash price of $500, based on a cash-to-points conversion factor of 100 points/dollar, the updated points price may be based on an alternative conversion factor. For example, the loyalty program may instruct that based on the “your points go further” deal described, the conversion factor becomes 90 points/dollar. Therefore, the updated points price, based on the loyalty program deal becomes 45,000 points for a tablet computer with a cash price of $500.

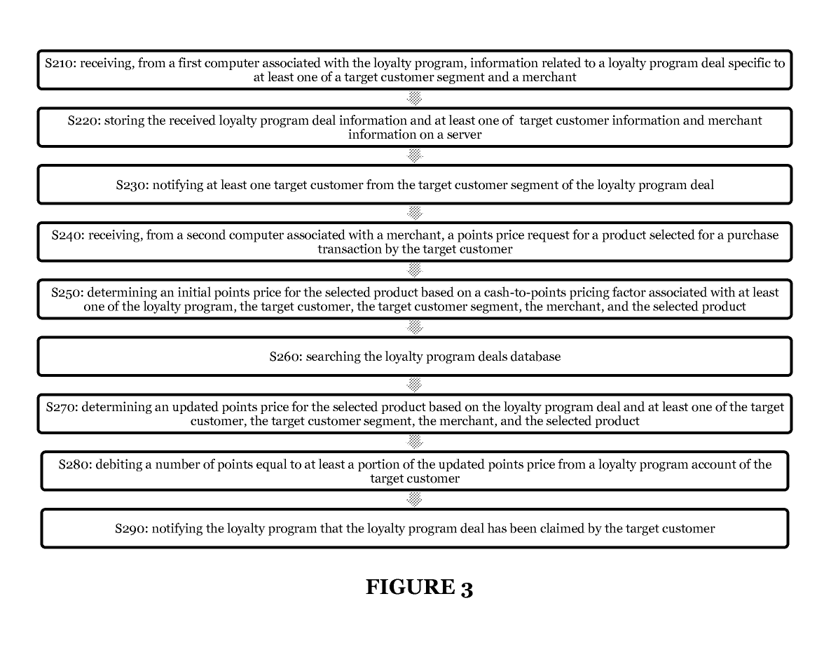

As shown in FIG. 4, in a preferred embodiment, the method includes block S272, which recites notifying the customer whether a loyalty program deal has been applied to the transaction. Block S272 preferably functions to enable the customer to verify that a desired loyalty program deal has been claimed with his or her transaction. In one variation, the method preferably includes notifying the customer that a loyalty program deal has been applied to the transaction and/or notifying the customer of the updated points price of the selected product. In another variation, the method preferably includes notifying the customer that a loyalty program deal has not been applied to the transaction, such as with a general message stating such and/or with reasons that the loyalty program deal was not applied to the transaction (e.g., ineligible product type or product cost, ineligible merchant). These notifications are preferably communicated to the customer in a manner similar to notifying the target customer of the loyalty program deal. In another embodiment, the method additionally or alternatively includes block S274, which recites communicating to the e-commerce agent whether a loyalty program deal has been applied to the transaction, such that the e-commerce agent can notify the customer whether a loyalty program deal has been applied to the transaction, in messages similar to those described above.

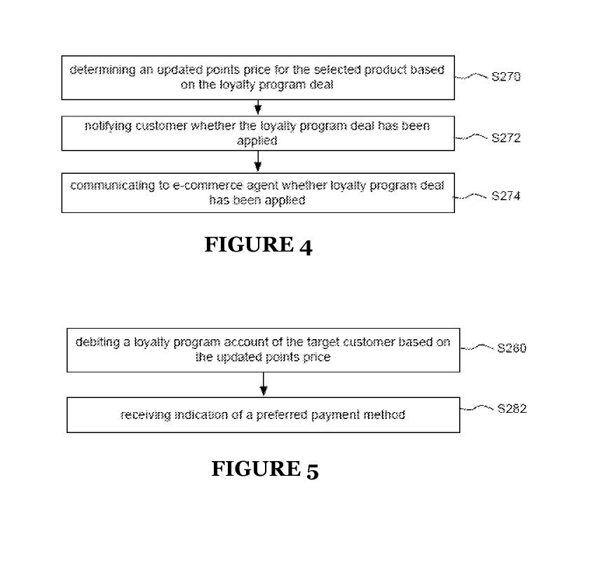

Returning to FIG. 3, in a preferred embodiment, the method includes block S280 which recites debiting a number of points equal to at least a portion of the updated points price from a loyalty program account of the target customer. Block S280 preferably functions to complete the transaction with the selected product at the updated points price. The method preferably includes linking to a loyalty program account of the customer and debiting, preferably in real-time, at least a portion of the updated points price from the loyalty program account of the customer. As shown in FIG. 5, in some preferred embodiments, the method includes block S282, which recites receiving an indication of a preferred payment method, such as from the customer and/or e-ecommerce agent. The payment method may be entirely in loyalty program points, entirely in cash currency, or a combination of loyalty program points and cash currency. The customer can set a default preferred payment method, or the method can include prompting the customer to select a preferred payment method. Depending on the preferred payment method selected by the customer, any one or more suitable accounts may be debited and/or charged. Debiting and/or charging the one or more payment accounts may additionally or alternatively be performed by the e-commerce agent.

In a preferred embodiment, as shown in FIG. 3, the method includes block S290, which recites notifying the loyalty program that the loyalty program deal has been claimed by the target customer. Block S290 preferably functions to communicate with the loyalty program and/or merchant, and to notify that the deal has been claimed by the customer. For example, such information can enable tracking of metrics (e.g., popularity of the loyalty program deal). In some embodiments, the method may notify the loyalty program and/or merchant that the deal was not claimed. For example, the message may indicate that there was an error or that the customer did not choose to utilize the deal.

The system and methods of the preferred embodiment can be embodied and/or implemented at least in part as a machine configured to receive a computer readable medium storing computer-readable instructions. The instructions are preferably executed by computer-executable components preferably integrated with the system. The computer-readable medium can be stored on any suitable computer readable media such as RAMs, ROMs, flash memory, EEPROMs, optical devices (CD or DVD), hard drives, floppy drives, or any suitable device. The computer-executable component is preferably a general or application specific processor but any suitable dedicated hardware device or hardware/firmware combination device can (alternatively or additionally) execute the instructions. Although omitted for clarity, the preferred embodiments of the method include every combination and permutation of the processes described herein. It should be understood that any of the foregoing processes can be performed by any suitable device, in any suitable order, in a serial or parallel manner.

### Example Implementation of the System and Method

The following example implementation of the preferred system and method is for illustrative purposes only, and should not be construed as definitive of limiting of the scope of the claimed invention. In one illustrative example, a loyalty program X from a particular airline would like to offer a particular target customer (or customer segment) a loyalty program deal Y that provides 1,000 free miles (or “points”) toward a purchase of over $100 made at Merchant Z, as shown in FIG. 4 for example. A loyalty program deals database receives (from a user interface used by loyalty program X) and stores information related to loyalty program deal Y, including at least (1) member identification of the customer, (2) identification of Merchant Z, (3) valid dates of the loyalty program deal from loyalty program X, (4) the mileage bonus of 1,000 free miles, and (5) a notification message of “Go to Merchant Z and use your free 1,000 miles for a purchase over $100” to provide to the user. The target customer is sent an email including the notification message.

Wishing to take advantage of the loyalty program deal, the customer visits Merchant Z (e.g., on the website of Merchant Z) and selects a tablet computer with a cash currency price of $500. The customer logs into payment partner wallet (such as PAYPAL or another e-commerce agent) that supports transactions with loyalty program X and Merchant Z. The e-commerce agent sends, to a transaction engine, a points price request including identification of Merchant Z and the $500 cash currency price of the computer. The transaction engine searches a pricing factors database for the cash-to-points pricing factor applicable to the customer and determines an applicable cash-to-points pricing factor of 100 (100 points/$). The transaction engine determines an initial points price for the computer of 50,000 points ($500×100 points/$=50,000 points) from loyalty program X. The transaction engine further searches the loyalty program deals database for any applicable discounts, bonuses, or other deals, and retrieves loyalty program deal Y. The transaction engine checks the transaction criteria (e.g., purchase over $100 at Merchant Z) and determines that the loyalty program deal Y is valid for the transaction. The transaction engine applies the valid loyalty program deal Y toward the transaction and determines an updated points price for the computer of 49,000 (50,000−1,000=49,000) points from loyalty program X.

After determining the updated points price for the computer, the transaction engine informs the customer with a message, “Congratulations! Your free 1,000 miles have been applied to your 50,000 point purchase, leaving you a 49,000 point balance.” The transaction engine also informs the payment partner wallet that loyalty program deal Y has been applied to the transaction, and the payment partner wallet displays to the customer the 49,000 point price and any further marketing messages that contain the deal information. The customer then opts to complete the transaction by paying with his accrued miles or points in his account with loyalty program X, from which the transaction engine proceeds to debit the 49,000 point balance. Following completion of the transaction, the transaction engine reports to loyalty program X and/or Merchant Z that loyalty program deal Y was claimed.

As a person skilled in the art will recognize from the previous detailed description and from the figures and claims, modifications and changes can be made to the preferred embodiments of the invention without departing from the scope of this invention defined in the following claims.

We claim:

1. A system for offering a loyalty program deal to a target customer and for enabling use of points from a loyalty program as payment, the system comprising:
a loyalty program deals database configured to store information related to a loyalty program deal specific to at least one of a target customer segment and a merchant;
a pricing factors database configured to store a plurality of cash-to-points pricing factors associated with at least one of loyalty programs, target customer segments, merchants, and selected products;
a transaction engine coupled to the loyalty program deals database and the pricing factors database and configured to determine an initial points price for a product selected by the target customer based on a selected cash-to-points pricing factor, and to determine an updated points price for the selected product based on the loyalty program deal and at least one of the target customer, the target customer segment, the merchant, and the selected product;
a payment module configured to debit a loyalty program account of the target customer; and
a messaging module coupled to the transaction engine and configured to communicate information to at least one of the loyalty program and the target customer.

2. The system of claim 1, wherein the initial points price for the selected product is preferably based on a cash-to-points pricing associated with at least one of the target customer and the selected product.

3. The system of claim 1, further comprising a user interface configured to receive loyalty program deal information to be stored in the loyalty program deals database.

4. The system of claim 1, wherein the transaction engine is further configured to communicate with a payment wallet or other e-commerce agent, which interfaces with the merchant during the transaction of the target customer.

5. The system of claim 1, wherein the transaction engine is configured to communicate and interface directly with the merchant.

6. The system of claim 1, wherein the pricing factors database is configured to store a plurality of tiers of cash-to-points pricing factors.

7. The system of claim 1, wherein the pricing factors database is coupled to the loyalty program deals database to enable a loyalty program deal to specify a particular cash-to-points pricing factor value.

8. The system of claim 1, wherein the transaction engine is further configured to determine an appropriate cash-to-points pricing factor for the selected product.

9. The system of claim 1, wherein the payment module is further configured to receive an indication of at least one of a number of loyalty program points to debit from a loyalty program account and a cash amount to debit from a cash currency account or credit card.

10. A method for offering a loyalty program deal to a target customer and for enabling use of points from a loyalty program as payment, the method comprising the steps of:
receiving, from a first computer associated with the loyalty program, information related to a loyalty program deal specific to at least one of a target customer segment and a merchant;
storing the received loyalty program deal information and at least one of target customer information and merchant information on a server;
notifying at least one target customer from the target customer segment of the loyalty program deal;
receiving, from a second computer associated with a merchant, a points price request for a product selected for a purchase transaction by the target customer;
determining an initial points price for the selected product based on a cash-to-points pricing factor associated with at least one of the loyalty program, the target customer, the target customer segment, the merchant, and the selected product;
determining an updated points price for the selected product based on the loyalty program deal and at least one of the target customer, the target customer segment, the merchant, and the selected product;
debiting a number of points equal to at least a portion of the updated points price from a loyalty program account of the target customer; and
notifying the loyalty program that the loyalty program deal has been claimed by the target customer.

11. The method of claim 10, wherein the target customer segment includes a single individual customer.

12. The method of claim 10, further comprising the step of verifying the eligibility of the purchase transaction by the target customer for the loyalty program deal.

13. The method of claim 10, wherein the step of notifying a target customer further comprises notifying a target customer of the loyalty program deal with a stored deal notification message text.

14. The method of claim 10, wherein the step of receiving a points price request for a product further comprises receiving at least one of an identification of the product, cash currency price of the product, customer identification information, and merchant identification information.

15. The method of claim 10, wherein the step of receiving a points price request for a product further comprises receiving a points price request through an e-commerce agent into which a target customer is logged in.

16. The method of claim 10, further comprising the step of determining an applicable cash-to-points pricing factor based on at least one of product type, product dollar price, customer demographic, merchant, and loyalty program.

17. The method of claim 10, further comprising the step of searching the loyalty program deals database for at least one applicable loyalty program deal.

18. The method of claim 10, further comprising the step of notifying a customer of the status of a loyalty program deal application to the transaction.

19. The method of claim 10, further comprising the step of notifying a merchant of the status of a loyalty program deal application to the transaction.

20. The method of claim 10, wherein the wherein the step of debiting a loyalty program account further comprises receiving an indication of a preferred payment method, wherein the payment method may be entirely in loyalty program points, entirely in cash currency, or a combination of loyalty program points and cash currency.
